(19) United States
(12) Patent Application Publication
(10) Pub. No.: US 2011/0270947 A1
(43) Pub. Date: Nov. 3, 2011

(54) DIGITAL IMAGING METHOD EMPLOYING USER PERSONALIZATION AND IMAGE UTILIZATION PROFILES

(76) Inventors: Ronald S. Cok, Rochester, NY (US); Kenneth A. Parulski, Rochester, NY (US); Timothy L. Nichols, Spencerport, NY (US); Charles L. Parker, Rochester, NY (US); Bryan D. Morgan, Ramona, CA (US); Daniel L. Ahlberg, Pleasanton, CA (US); Manish Sharma, Fremont, CA (US)

(21) Appl. No.: 12/769,954

(22) Filed: Apr. 29, 2010

(51) Int. Cl. G06F 15/16

(52) U.S. Cl. 709/217

(57) ABSTRACT

A method for creating image products and services for users connected to and in communication with a server through a computer network. User personalization profiles are generated and stored for each of the users and each personalization profile contains personal preferences for the plurality of users. Digital images are received from the plurality of client computers and are stored in a storage system on the digital image server. In response to a particular user selecting an image product or service using a stored digital image, the server automatically provides over the network a customized offering of a second product or service to the particular user. The offering is customized in response to at least one of the image usage profiles and in response to at least one of the user personalization profiles.

### CROSS REFERENCE TO RELATED APPLICATION

Reference is made to commonly assigned, co-pending U.S. patent application Ser. No. ______, entitled “DIGITAL IMAGING SYSTEM EMPLOYING USER PERSONALIZATION AND IMAGE UTILIZATION PROFILES” by Cok et al. (Docket 96265), filed concurrently herewith is assigned to the same assignee hereof, Eastman Kodak Company of Rochester, N.Y., and contains subject matter related, in certain respect, to the subject matter of the present application. The above-identified patent application is incorporated herein by reference in its entirety.

### FIELD OF THE INVENTION

The present invention relates to products or services that include digital images and, more particularly, to generating and employing information about the use of digital images and generating and employing information about the users of digital images in providing digital image products or services.

### BACKGROUND OF THE INVENTION

Digital imaging products and services are widely available, both at retail stores and on the internet. Typical products include frames, cards, calendars, and photo-books. These products incorporate consumer images mounted or composited into larger images that are printed and delivered to the consumers. The images include digital scans of printed images or digital images originally captured by digital cameras.

Creating imaging products such as a personalized calendar can be a time-consuming task, requiring many manual steps. For example, a user typically reviews a large number of calendar “templates” to find one which appeals to them. The calendars may use different themes, styles, colors, and text fonts, which must be selected by the user. Next, the user must manually select the images that they want to use for the calendar, such as one or more pictures to be featured for each month of the calendar. Finally, the user may manually select certain dates of the calendar, such as key birthdays or anniversaries, and manually add text, graphics, or images to highlight these dates.

Creating imaging services, such as audio—video slideshows or videos can also be a time-consuming task, requiring many manual steps. For example, a user typically reviews a large number of songs, in order to create a slide show that reflects their particular taste in music, to be used as an audio track for an audio—video slideshow.

Advertising is a common marketing technique for internet businesses. Notices, images, and text are presented to internet users through browsers or software applications communicating with web servers that sell products. Some businesses use such techniques on the internet to advertise popular products to users.

In an attempt to more closely target consumer interests, internet businesses often provide advertisements for products that are related to a product purchased by consumers or products that are similar to the purchased product. Consumers might be advised to purchase a second item that is like a purchased first item, for example a musical or video performance. In a different example, a consumer who purchased a computer might be advised to purchase a carrying case for that computer. In another example of targeted advertising, an internet business might advertise a discount or coupon for an additional product after a certain product volume or product value has been purchased.

Commonly-assigned U.S. Pat. No. 6,785,421, the disclosure of which is incorporated herein by reference in its entirety, describes a method of analyzing images to determine the likelihood of user interest in materials. Such materials might include products for sale. If the image analysis indicates interest, such materials can be sent for presentation to the user.

It also known in the prior art, for example with digital cameras, to tag images with metadata information related to the image contents or the image owner's preferences with respect to the image, such as tagging an image as a “favorite” image. Such favorite images can be preferred in actions taken with respect to the image or products that incorporate an image. Commonly-assigned U.S. Pat. No. 7,327,505 “Method for providing affective information in an imaging system” to Fedorovskaya et al., the disclosure of which is incorporated herein by reference in its entirety, discloses affective information that relates to the feelings or emotions of the user toward a digital image. The affective information can include physiological responses as well as the number and length of times an image is viewed, the image is printed, or the image is emailed.

Commonly-assigned U.S. Pat. No. 7,302,115, the disclosure of which is incorporated herein by reference in its entirety, teaches a method of offering a customized promotional product to a user. The method comprises the steps of: accessing a user-supplied digital image at a digital imaging device; providing a digital image representative of a promotional product, the promotional product digital image having a predetermined image location adapted to receive at least a portion of the user-supplied digital image; generating a modified user image by modifying the at least a portion of the user-supplied digital image to simulate an application of the at least a portion of the user-supplied image to the promotional product; generating a customized digital image representative of the customized promotional product, the customized digital image comprising the promotional product digital image having the modified user image disposed within the predetermined image location; and displaying the customized digital image to the user on a display of the digital imaging device. This technique presents a customer with an image of a product personalized with the customer's image, that the customer might wish to buy, so that the customer can better understand and appreciate the personalized product. This technique does not address the question of matching a customer's preferences with image products and specific images.

It is known to provide user profiles encompassing preferences, demographics, family members, and the like. For example, the organization databaseanswers.org has provided information on their website at the URL http://www.databaseanswers.org/data_models/crm_personalization/crm_personalization_dezign.htm which describes a customer relationship management (CRM) model which can be personalized to include customer loyalty information, such as dates of first and last purchases, household member information, such as the number of children and the number of wage earners, customer offer information, such as the dates that special offers were made and accepted, and customer product holdings, such as the type of products purchased and the date they were acquired.

It is also known to provide user profiles that help businesses understand the demographics, lifestyles, social media memberships, and “friend connections” of their customers. For example, the company RapLeaf describes on their website at URL http://www.rapleaf.com/insight a service that they provide which can help a musical artist understand the name, age, gender, location, and occupation of their fan base using information from social network websites such as Facebook and MySpace.

It is also known to use information related to past purchases to provide offers of products or services that may be of interest. For example, the website www.amazon.com provides “recommended” offers of items for sale using a method which they describe as “determining your interests by examining the items you've purchased, items you've told us you own, and items you've rated. We then compare your activity on our site with that of other customers. Using this comparison, we are able to recommend other items that may interest you. These recommended items will appear in several areas throughout our store.”

While the prior-art methods described above can be useful, they do not address all of the information or methods that might be employed to assist consumers in selecting imaging products that can be of interest to the consumers. In particular, they require much time and effort to complete the many manual steps needed to create an imaging product or service that reflects their personal taste, and which uses their favorite images. There is a need, therefore, for an improved method for providing imaging products and services to consumers.

### SUMMARY OF THE INVENTION

In accordance with the present invention, there is provided a method for creating image products and services. In particular, a digital image server stores collections of digital images for a plurality of users connected to and in communication with the remote server through a computer network. User personalization profiles are generated and stored for each of the users and each personalization profile contains personal preferences for the plurality of users. Digital images are received from the plurality of remote client computers and are stored in a storage system on the digital image server. Image usage profiles are also generated and stored for the digital images. They provide data indicating the uses of the stored digital images. In response to a particular user selecting an image product or service using a stored digital image, the server automatically provides over the network a customized offering of a second product or service to the particular user. The offering is customized in response to at least one of the image usage profiles and in response to at least one of the user personalization profiles.

The present invention discloses an improved method for providing imaging products and services to consumers and has the advantage of increasing consumer satisfaction with provided imaging products and services. These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. For example, the summary descriptions above are not meant to describe individual separate embodiments whose elements are not interchangeable. In fact, many of the elements described as related to a particular embodiment can be used together with, and possibly interchanged with, elements of other described embodiments. In particular, descriptions of steps that are repeatedly used in several embodiments are not repeatedly described for each embodiment. However, it should be understood that the flow charts having steps labeled with similar descriptive text are described with reference to the earlier Figure containing that labeled step. Many changes and modifications may be made within the scope of the present invention without departing from the spirit thereof, and the invention includes all such modifications. The figures below are intended to be drawn neither to any precise scale with respect to relative size, angular relationship, or relative position nor to any combinational relationship with respect to interchangeability, substitution, or representation of an actual implementation.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 illustrates a computer system for use in a preferred embodiment of the present invention;

FIG. 2 illustrates a user operating a computer system in a preferred embodiment of the present invention;

FIG. 3 is a schematic illustrating a computer system and network useful in a method of the present invention;

FIG. 4 is a flow diagram illustrating a method according to an embodiment of the present invention;

FIG. 5 is a flow diagram illustrating an alternative method according to an embodiment of the present invention;

FIG. 6 is a flow diagram illustrating another method according to an embodiment of the present invention;

FIG. 7 is a flow diagram illustrating a portion of a method according to an embodiment of the present invention;

FIG. 8 is a flow diagram illustrating a portion of a method according to an embodiment of the present invention;

FIGS. 9A and 9B are tables illustrating digital image use information in a method of the present invention;

FIG. 10 is a table illustrating user profile information useful in a method of the present invention;

FIG. 11 is a table illustrating user profile information and image use information useful in a method of the present invention; and

FIG. 12 is a flow diagram illustrating a portion of a method according to an embodiment of the present invention.

### DETAILED DESCRIPTION OF THE INVENTION

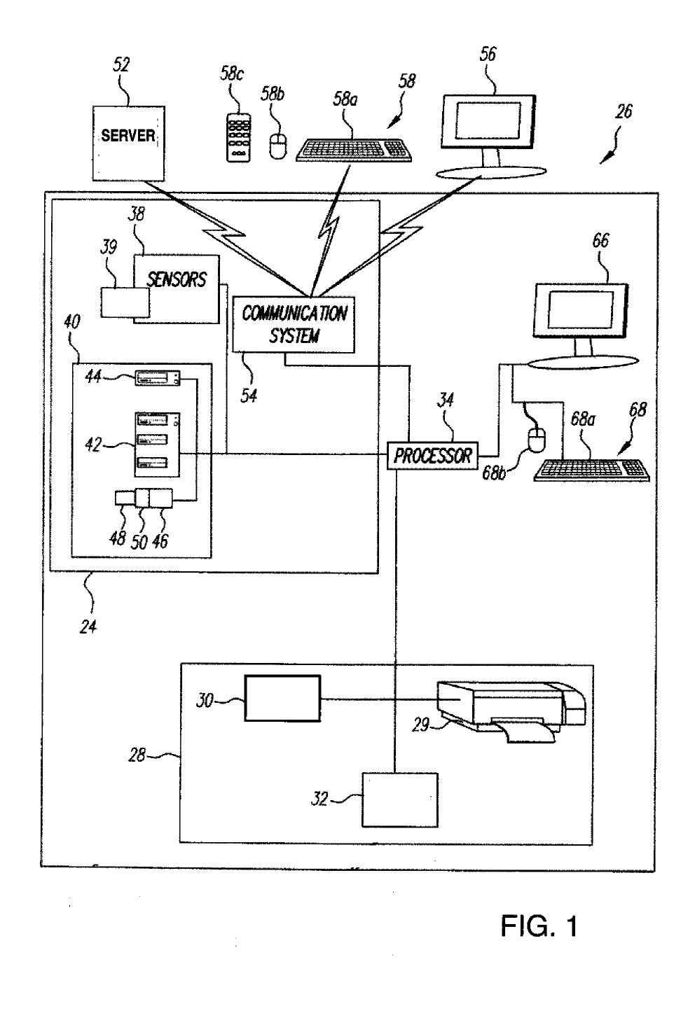

FIG. 1 illustrates a first embodiment of an electronic system 26, a computer system, for implementing certain embodiments of the present invention for automatically generating image products and services. In the embodiment of FIG. 1, electronic computer system 26 comprises a source of content and program data files 24 such as software applications, image use profiles, user profiles, and image files, and which includes various memory and storage devices 40, a wired user input system 68 as well as a wireless input system 58, and an output system 28, all communicating directly or indirectly with processor 34. Although not shown, processor 34 is meant to illustrate typical processor system and chip components such as instruction and execution registers, an ALU, various levels of cache memory, etc. The source of program and content data files 24, user input system 68, or output system 28, and processor 34 can be located within a housing (not shown). In other embodiments, circuits and systems of the source of content and program data files 24, user input system 68 or output system 28 can be located in whole or in part outside of a housing.

The source of content or program data files 24 can include any form of electronic, optical, or magnetic storage such as optical discs, storage discs, diskettes, flash drives, etc., or other circuit or system that can supply digital data to processor 34 from which processor 34 can load software, user profiles, image use profiles, image files, and other image information such as image metadata including derived and recorded metadata. In this regard, the content and program data files can comprise, for example and without limitation, software applications, a still image data base, image sequences, a video data base, graphics, and computer generated images, image usage information associated with still, video, or graphic images, user usage profiles, and any other data necessary for practicing embodiments of the present invention as described herein. Source of content data files 24 can optionally include devices to capture images to create image data files by use of capture devices located at electronic computer system 20 and/or can obtain content data files that have been prepared by or using other devices or image enhancement and editing software. In the embodiment of FIG. 1, sources of content or program data files 24 include sensors 38, a memory and storage system 40 and a communication system 54.

Sensors 38 can include one or more cameras, video sensors, scanners, microphones, PDAs, palm tops, laptops that are adapted to capture images and can be coupled to processor 34 directly by cable or by removing portable memory 39 from these devices and/or computer systems and coupling the portable memory to slot 46. Sensors 38 can also include biometric or other sensors for measuring physical and mental reactions. Such sensors including, but not limited to, voice inflection, body movement, eye movement, pupil dilation, body temperature, and p4000 wave sensors.

Memory and storage 40 can include conventional digital memory devices including solid state, magnetic, optical or other data storage devices, as mentioned above. Memory 40 can be fixed within system 26 or it can be removable and portable. In the embodiment of FIG. 1, system 26 is shown having a hard disk drive 42, which can be an attachable external hard drive, which can include an operating system for electronic computer system 26, and other software programs and applications such as the program algorithm embodiments of the present invention, a template design data base, derived and recorded metadata, image files, image attributes, software applications, and a digital image data base. A disk drive 44 for a removable disk such as an optical, magnetic or other disk memory (not shown) can also include control programs and software programs useful for certain embodiments of the present invention, and a memory card slot 46 that holds a removable portable memory 48 such as a removable memory card or flash memory drive or other connectable memory and has a removable memory interface 50 for communicating with removable memory 48. Data including, but not limited to, control programs, template designs, derived and recorded metadata, digital image usage files, user attributes, image attributes, software applications, digital images, and metadata can also be stored in a remote server 52 such as a personal computer, computer network, a network connected server, or other digital system having a memory system for data storage.

In the embodiment shown in FIG. 1, system 26 has a communication system 54 that in this embodiment can be used to communicate with an optional remote input 58, remote server system 52, an optional remote display 56, for example by transmitting image designs in the form of calendar template designs with or without merged images and receiving from remote server system 52, a variety of control programs, template designs, derived and recorded metadata, image files, image attributes, and software applications. Although communication system 54 is shown as a wireless communication system, it can also include a modem for coupling to a network over a communication cable for providing to the computer system 26 access to the network and server system 52. A remote input station including a remote display 56 and/or remote input controls 58 (also referred to herein as “remote input 58”) can communicate with communication system 54 wirelessly as illustrated or, again, can communicate in a wired fashion. In a preferred embodiment, a local input station including either or both of a local display 66 and local user input controls 68 (also referred to herein as “local user input 68”) is connected to processor 34 which is connected to communication system 54 using a wired or wireless connection.

Communication system 54 can comprise for example, one or more optical, radio frequency or other transducer circuits or other systems that convert data into a form that can be conveyed to a remote device such as server 52 or remote display 56 using an optical signal, radio frequency signal or other form of signal. Communication system 54 can also be used to receive a digital image and other data, as exemplified above, from a host or server computer or network (not shown), a server 52 or a remote input 58. Communication system 54 provides processor 34 with information and instructions from signals received thereby. Typically, communication system 54 will be adapted to communicate with the server 52 by way of a communication network such as a conventional telecommunication or data transfer network such as the internet, and peer-to-peer; cellular or other form of mobile telecommunication network, a local communication network such as wired or wireless local area network or any other conventional wired or wireless data transfer system.

User input system 68 provides a way for a user of system 26 to provide instructions to processor 34, such instructions comprising automated software algorithms of particular embodiments of the present invention that automatically generate coordinated image templates according to selected template designs. This software also allows a user to make a designation of content data files, such as selecting calendar templates and designating digital image files, to be used in automatically generating an image enhanced output calendar product according to an embodiment of the present invention and to select an output form for the output product. User controls 68a, 68b or 58a, 58b in user input system 68, 58, respectively, can also be used for a variety of other purposes including, but not limited to, allowing a user to arrange, organize and edit content data files, such as coordinated image displays and calendar image templates, to be incorporated into the image output product, for example, by incorporating image editing software in computer system 26 which can be used to override design automated image output products generated by computer system 26, as described below in certain preferred method embodiments of the present invention, to provide information about the user, to provide annotation data such as text data, to identify characters in the content data files, and to perform such other interactions with system 26 as will be described later.

In this regard user input system 68 can comprise any form of device capable of receiving an input from a user and converting this input into a form that can be used by processor 34. For example, user input system 68 can comprise a touch screen input 66, a touch pad input, a multi-way switch, a stylus system, a trackball system, a joystick system, a voice recognition system, a gesture recognition system, a keyboard 68a, mouse 68b, a remote control or other such systems. In the embodiment shown in FIG. 1, electronic computer system 26 includes an optional remote input 58 including a remote keyboard 58a, a remote mouse 58b, and a remote control 58c. Remote input 58 can take a variety of forms, including, but not limited to, the remote keyboard 58a, remote mouse 58b or remote control handheld device 58c illustrated in FIG. 1. Similarly, local input 68 can take a variety of forms. In the embodiment of FIG. 1, local display 66 and local user input 68 are shown directly connected to processor 34.

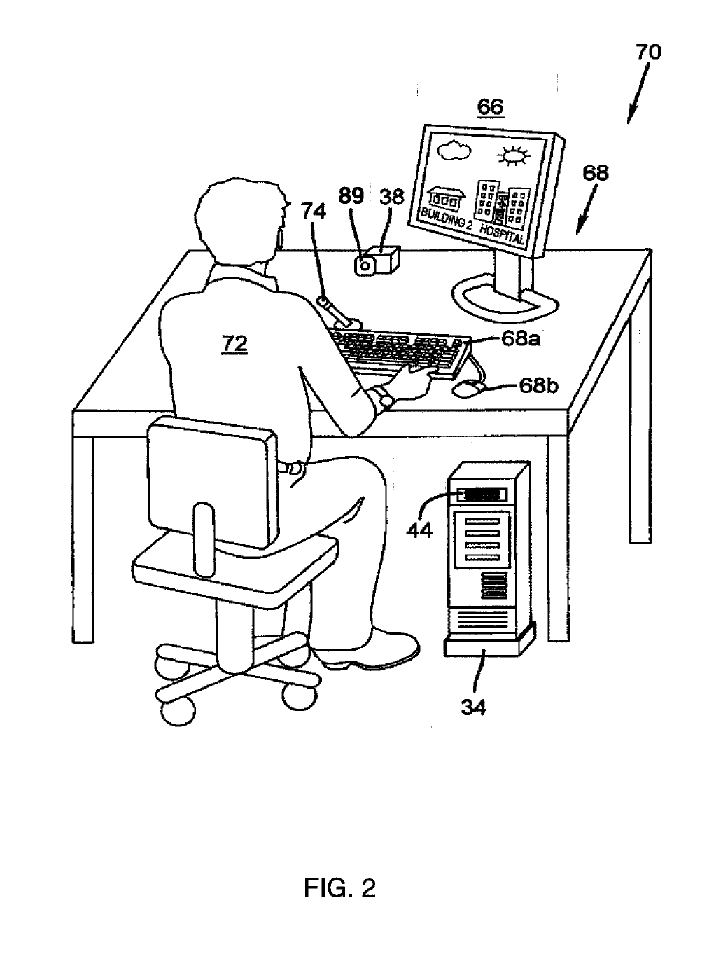

As is illustrated in FIG. 2, computer system 26 and local user input system 68 can take the form of an editing studio or kiosk 70 (hereafter also referred to as an “editing area 70”), although this illustration is not intended to limit the possibilities as described in FIG. 1 of editing studio implementations. In this illustration, a user 72 is seated before a console comprising local keyboard 68a and mouse 68b and a local display 66 which is capable, for example, of displaying multimedia content. As is also illustrated in FIG. 2, editing area 70 can also have sensors 38 including, but not limited to, camera or video sensors 38 with built-in lenses 89, audio sensors 74 and other sensors such as, for example, multispectral sensors that can monitor user 72 during a user or production session.

Output system 28 (FIG. 1) is used for rendering images, text, completed or uncompleted digital image templates and other digital image output products, or other graphical representations in a manner that allows an image output product to be generated. In this regard, output system 28 can comprise any conventional structure or system that is known for printing, displaying, or recording images, including, but not limited to, printer 29. For example, in other embodiments, output system 28 can include a plurality of printers 29, 30, 32, and types of printers, including transfer machines capable of screen printing t-shirts and other articles. Processor 34 is capable of sending print commands and print data to a plurality of printers or to a network of printers. Each printer of the plurality of printers can be of the same or a different type of printer, and each printer may be able to produce prints of the same or a different format from others of the plurality of printers. Printer 29 can record images on a tangible surface, such as on, for example, various standard media or on clothing such as a T-shirt, using a variety of known technologies including, but not limited to, conventional four-color offset separation printing or other contact printing, silk screening, dry electrophotography such as is used in the NexPress 2100 printer sold by Eastman Kodak Company, Rochester, N.Y., USA, thermal printing technology such as in thermal printer 30, drop on demand ink jet technology and continuous inkjet technology. For the purpose of the following discussions, printers 29, 30, 32 will be described as being of a type that generates color images. However, it will be appreciated that this is not necessary and that the claimed methods and apparatuses herein can be practiced with printers 29, 30, 32 that print monotone images such as black and white, grayscale or sepia toned images.

In certain embodiments, the source of content data files 24, user input system 68 and output system 28 can share components. Processor 34 operates system 26 based upon signals from user input system 58, 68, sensors 38, memory 40 and communication system 54. Processor 34 can include, but is not limited to, a programmable digital computer, a programmable microprocessor, a programmable logic processor, a series of electronic circuits, a series of electronic circuits reduced to the form of an integrated circuit chip, or a series of discrete chip components.

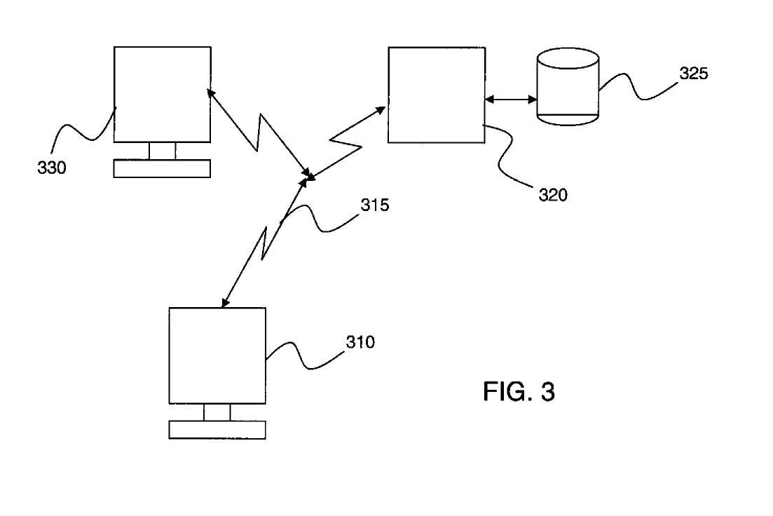

Referring to FIG. 3, a client computer 310 interacts through a computer network 315, for example the internet, with a digital image server 320. The digital image server 320 includes or has access to a storage system 325 for the digital images. A second server 330 can also interact with the digital image server 320 and with other client computers (not shown), including the client computer 310. The client computer 310 can be a desktop or laptop computer or a mobile phone, tablet computer, set-top box, or another device having sufficient computational capability and that is connected, either directly or indirectly, to the computer network 315 such as the internet. The client computer 310 can communicate over the computer network 315 to a plurality of photo service providers who may, optionally, own image server 325. U.S. Pat. No. 7,275,044 entitled “System, method, and software product for ordering image products over a communications network from a plurality of different providers having different business relationships” to Chauvin, et al., the disclosure of which is incorporated herein by reference in its entirety, describes an example of client computers communicating with a plurality of photo service providers over a computer network.

In one method of the present invention, the digital images are accessed through a remote client computer 310 connected to a second server 330, the second server 330 having access to the digital images on the digital image server 320 and providing the digital images to the remote client computer 310. In this way, the owner can access the digital images through the second server 330, or a person who is not the owner can access the digital images through the second server 330. For example, digital images can be distributed through other services, such as social networking sites, having clients and servers separate from the server that stores, or has direct access to, the digital images. Such access can be facilitated through a second server 330 that provides the other services, such as social networking.

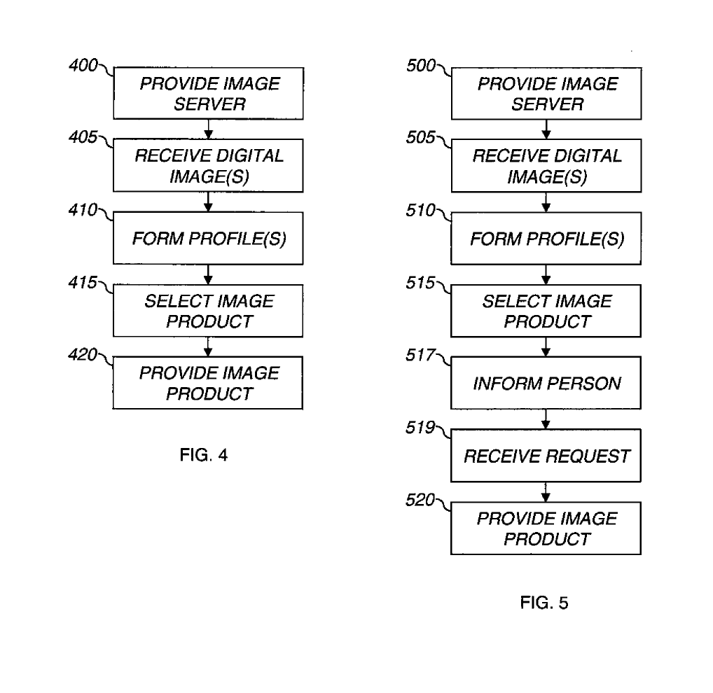

Referring to FIG. 4, a method for providing imaging products and services comprises the steps of providing a first digital image server computer having a storage system for storing digital images in response to a remote client computer connected to and in communication with the remote server through a computer network in step 400. The computer network can be the internet. It will be understood that a large number of client computers can be connected to the remote server in order to support a large number of users, each user having a collection of digital images.

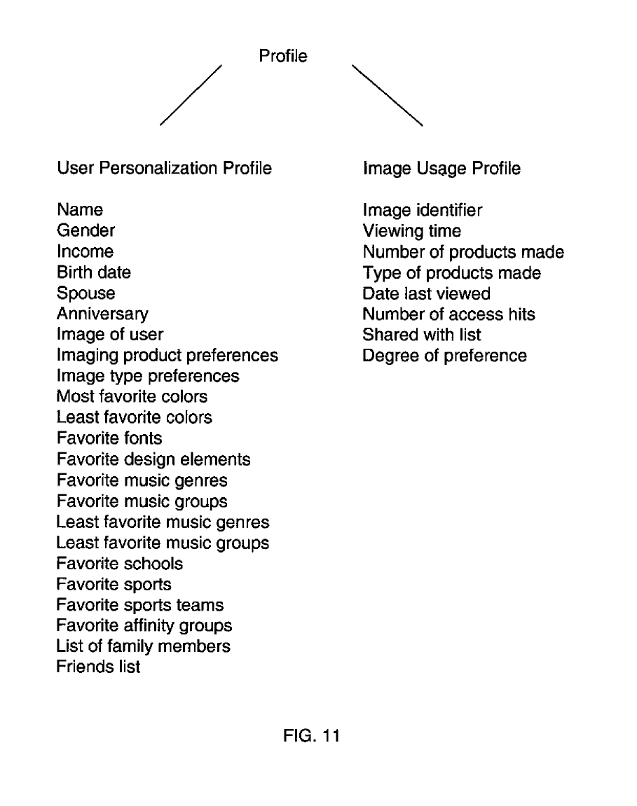

The first digital image server receives digital images from a user, who may be an owner of the digital images, by means of the client computer and stores them in the storage system on the digital image server in step 405. The first digital image server forms one or more profiles of the user or of the digital images or both in step 410, as will be described in more detail in reference to FIG. 11.

As used herein, a profile is a set of characteristics, attributes, qualities, or history. The profile can include information about the use of digital images or information about a user of the digital images, or both. A profile can include the preferences of a particular user, in which case the profile is referred to as a user personalization profile. A profile can include data indicating how one or more images have been used, for example how often they have been viewed, printed, or distributed electronically, in which case the profile is referred to as an image usage profile.

The information in the profile can be stored in a single database. Alternatively, an image usage profile containing information about a specific digital image can be stored with that digital image as metadata, or in a separate file associated with the digital image, for example by a naming or location convention. Likewise, separate personalization profile files can be kept for each user, in the case that multiple users are selecting imaging products and services using the same collection of digital images. Each user personalization profile can be associated with a different user of digital images, or with a group of users having common characteristics. The digital images may be images in a common image collection for a group of users, or in different collections for each user.

Hence, profile data can, in general, include information about one or multiple users, one or multiple digital images, and can be stored in one or multiple locations. If the profile is stored in files at different locations or on different media, the files can be mutually referential. These distributed storage methods and file structures are known in the database art. The step of forming a profile can include the step of modifying an existing profile with new or different information. The step of forming a profile can also include the step of reading information from a user personalization profile on a first image server associated with a social networking website (e.g. Facebook or MySpace) and using the information to develop a user personalization profile more directly related to digital imaging products and services.

In step 415, the first digital image server selects an image product or image service, based on the profile, from a group of image products or image services and a user personalization profile. The user personalization profile can be for a user that has stored digital images on the server or requested products. The first digital image server then provides a customized offering of a selected image product or image service, in step 420. The selected image product or image service can include one or more of the digital images. The selection can be customized. A customized selection means that the selection was made based on knowledge of the user (from the user personalization profile) and the image use profile. Customizing can also mean that the selected image product or service is modified in some regard based on knowledge of the user (from the user personalization profile) and the image use profile. Thus, the selection is a customized commercial offering of an image product or service. If the selected customized offering is accepted, the transaction is completed using any one of a number of standard internet payment methods, and the selected product is shipped.

Referring to FIG. 5, after an image product or service is selected (step 515), a user of the client computer, or another user, can be informed of the customized offering selected (step 617) by the digital image server and the digital image server can receive a request for the image product or service from the user (step 619). The user can be the owner of the digital image or the one who originally transferred the digital image from the client computer to the digital image server and the storage system through the computer network. Alternatively, the user of the client computer can be a person who is not the owner of the digital image, for example a person who has an interest in the digital image because of shared interests, relationships, or activities with the owner.

Thus, according to an embodiment of the present invention, a method for providing imaging products and services comprises the steps of providing a first digital image server having a storage system for storing collections of digital images for a plurality of users in response to a plurality of remote client computers connected to and in communication with the remote server through a computer network; forming a user personalization profile for each of the plurality of users, each user personalization profile providing personal preferences for one of the plurality of users; receiving digital images from the plurality of remote client computers and storing the digital images in the storage system on the digital image server; forming image usage profiles for the stored digital images, the image usage profiles providing data indicating how often the stored digital images have been used; and responsive to a particular one of the plurality of users selecting, from a remote client computer, a first image product or service using a first stored digital image, automatically providing a customized offering of a second product or service to the particular user, wherein the customized offering is customized in response to at least one of the image usage profiles and in response to at least one of the user personalization profiles.

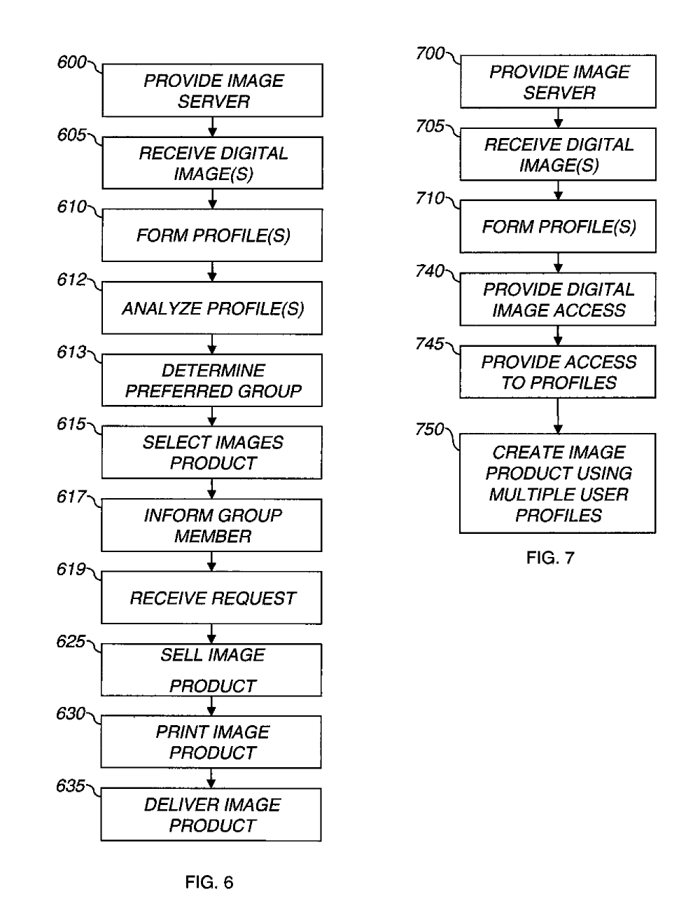

Referring to FIG. 6, the profiles can be analyzed in step 612 to determine a preferred group (step 613) to assist in selecting the image products or services (step 615). For example, analysis of the profiles can determine that a group of several people have user profile data stored on the server that each defines similar interests and image profiles contain data indicating that this group of several people has an interest in the same digital images. This data is used, as described below, to automatically select an image product or service. This group may likewise have a preferred image product or service referenced in their profiles. The digital image server can then select the preferred image product or service (step 615) as described below, inform one or more of the group members in step 617 that a product or service has been selected, and receive a request from one or more of the preferred group members (step 619). The selected image product or service is then sold to the preferred group members (step 625), the image product is produced (e.g. printed) and delivered (step 635). In an alternative embodiment, the user may have a relationship to another person that is a member of a group and the image product or service can be selected based on the preferences of the group. This can be accomplished by accessing the personalization profiles of the group, creating a list of any common preferences, and selecting the preference that is held by the greatest number of group members. In such a case, the selected image product or service can be a gift to the other person.

As shown in FIG. 11, a profile file can include a user personalization profile, an image usage profile, or both. An image usage profile includes a use record for one or more digital images, that can be identified using image identifiers and that records for each of the identified images, for example, the time spent viewing the digital image, the number and type of products (e.g. prints, photobooks) made using the digital image. The image usage profile can also include the date that the image was last viewed, the number of access hits to a web-page displaying the digital image by the owner, or by one or more persons who are not the owner. The image usage profile can also include a “shared with list” of people with whom the image has been shared, for example by email. The image usage profile can include a degree of preference for the image, as described in commonly assigned U.S. Pat. No. 7,327,505 entitled “Method for providing affective information in an imaging system” to Fedorovskaya et al. This degree of preference can include a rating manually input by a user, such as a “star rating” of one to five stars. The image usage profile can include the use of the digital images by people who are not the owner as well as use of the digital images by the owner.

The profile can be a user personalization profile that includes information about a particular user. This information can include, for example personal information such as the user's name, nickname, gender, approximate income level, birth date, marital status and anniversary, and spouses name. The user personalization profile can also include one or more images of the user, such as a portrait image that identifies the user.

The user personalization profile can also include imaging product preferences, image type preferences, and a history of prior imaging product purchases. The imaging product preferences can include a preference for certain types of products (e.g. albums or separate prints), a particular type of print (e.g. 4×6 or 3×5, glossy or matte finish, border or no border). The image type preferences can include the type of images (mood, level of color saturation, contrast level) preferred by the user based on image analysis of the user's preferred images. The history of prior imaging product purchases can determine, for example, if the user prints images on a regular basis, prints cards on a repeating basis (e.g. Christmas or New Year's Day cards).

The user personalization profile can also include information about the personal tastes of the user. This information can, in many cases, be automatically determined by analyzing one or more social network web sites associated with the user, such as their personal MySpace or Facebook page. The information in the user personalization file can include, for example, the user's most favorite colors, and also the user's least favorite colors, as well as typefaces, graphics, templates, or other design elements the user prefers for greeting cards, calendars, and the like. The information can also include the user's favorite music genres and groups, and can also include their least favorite genres and groups. The information can include the user's favorite schools, such as their alma mater. The information can include the user's favorite sports, and favorite athletes or sports teams.

The user personalization profile can also include a list of family members, and a “friends” list. The information used to identify family members and friends can include links to the user personalization profiles of these family members and friends.

The user personalization profile can be linked to the image usage profiles of any digital images found to be of interest (viewed, printed, emailed, etc.) by the user. Similarly, the image usage profile of a digital image can be linked to the user personalization profiles of any user that has used the digital image.

The information in the user personalization profile can be gathered from a variety of sources, for example direct interaction with an image fulfillment server, from image origination devices (e.g. digital image cameras or scanners), or from personal web-pages found, for example, in social network sites. As noted above, the profile information (relating to both image use and image users) can be stored in a common database or distributed among separate files, possibly located on separate computers. Such computers can include servers used for image product fulfillment or social networking websites employed by users for social interactions.

Image products can include, for example, prints, post cards, albums, calendars, mugs, and the like. Certain types of users, for example grandparents, can have certain types of preferred products, for example calendars, while other types of users, for example friends, can have different types of preferred products, for example post cards or albums. Note that in some cases, the owner of the image may not be a subject within the image, e.g. a picture taken of a friend. In other cases, a collection of images can be associated with a group of individuals with a common interest in a certain type of product, such as an album, that commemorates an activity the group enjoyed together. All the foregoing example profile data can be stored in user and image profile files accessible by the server.

To facilitate interactions between members of a group, referring to FIG. 7 in another embodiment of the present invention, a digital image, a reference to a digital image, or access to a digital image can be provided in step 740 from the digital image owner to another person who is not the owner, for example. In step 745, a profile (such as a user personalization profile), a reference to the profile, or access to the profile or a subset of the information within the profile (as controlled by the owner of the information, for example) can be provided. An image product using the information in multiple user personalization profiles can be created in step 750.

In one example of the embodiment of FIG. 7, a user can be given permission to access the information in the user personalization profiles of many different friends and family members, in order to create an image product. The image product could be a calendar, and the user personalization profiles can be used to provide the name, birthday, and image of each friend or family member. In step 750, the digital image server can automatically use the information in each of the user personalization profiles to create a calendar which indicates the birthday of each friend or family member on the appropriate day of the month. The calendar can also show the image of the particular friend or family member, provided in the user personalization profile for that friend or family member, overlaying the appropriate day of the year on the calendar, or as one of the images used for that month of the year.

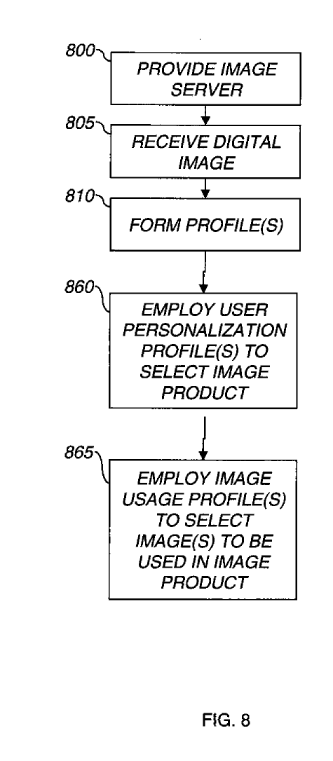

To facilitate the automatic creation of image products that are likely to appeal to a particular user, both the user personalization profile and the image usage profile can be used together, to select a particular type of image product and the particular images to be used in the image product as described below, and as shown in FIG. 8. In step 860, the user personalization profile can be employed to automatically select an image product, and to define options related to the image product as described below. For example, an audio/video slideshow product might be selected, using a particular type of music, or a particular artist, for the audio track, and using favorite colors for backgrounds or transitions. In step 865, image usage profiles can be used to automatically select the images to be used in the image product, such as the audio/video slideshow.

In another example which relates to an embodiment of FIG. 8, a gift from multiple family members, such as children or grandchildren, to a particular family member, such as a mother or grandmother, can be automatically produced by using information from the user personalization profiles (such as the favorite type of imaging products, and favorite colors, of the mother or grandmother), and also using preferred images from the image usage profiles of the multiple family members. In this case, a photo album could be automatically produced using the most preferred images of the family members taken during a particular period.

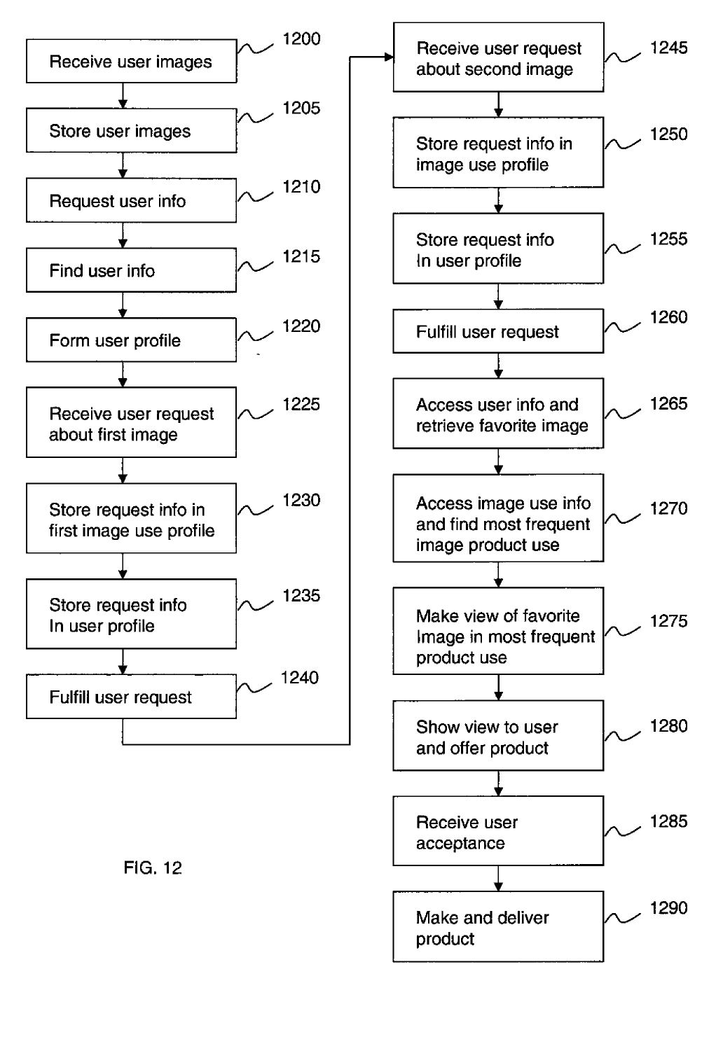

For example, referring to FIG. 12, a method according to an embodiment of the present invention includes receiving user images in step 1200. The user images are stored in a database or other storage system in step 1205. At a later time, at the same time, or before a user interacts with the system, user information is requested (step 1210) or obtained from the user or from other sources having information about the user (step 1215), and is stored on the server. The user information is employed to form a user profile (step 1220). At some time, the user requests information about, or an action relating to, a first image (step 1225). The request information can be stored in an image use profile for the first image (step 1230) and the user personalization profile (step 1235). If an image use profile does not yet exist, it can be created in response to the request. Likewise, if the user has not yet interacted with the system, a user personalization profile can be created in response to the request. The system then fulfils the request.

At the same time, before, or after the request is fulfilled, the user can make a second request for a second image (step 1245). The request can be for the same first image or for a different image so that the first and second images can be the same image or different images. As with the first image request, the second image request information is stored in the image use profile (step 1250) and the user profile (step 1255), and the user request fulfilled (step 1260). These communications as between users and the server or servers are repeated and, in this manner, the user profiles and the image profiles are accumulated and built over time. The user's user personalization profile is then accessed (step 1265) as well as image use info (step 1270) to select a customized product. Many different types of information can be use to select the customized product and the example given here is not limiting. For example, the user's favorite image can be determined from the user personalization profile and the most popular product made with that favorite image determined from the image use profile. Note that the most popular product can include choices made by others and that the favorite image does not necessarily belong to the user. A preview of the favorite image in the most popular product is made (step 1275) and shown to the user (step 1280) as a proposed product offering. The user can then accept the product offered (step 1285). After the commercial transaction is completed, the product can be made and delivered to the user (step 1290).

The offered product is customized in that the selection of image and product is dependent upon information in the user's personalization profile and the image use profile. Further customization can be provided, for example text or decorative elements can be determined from the user's personalization profile or the image use profile and used.

As described herein, a plurality of digital images can be incorporated in the selected image product or image service. For example, calendars, collages, slide shows, and photo albums can all incorporate multiple images. The selection of images to be used in the image product or image service can be based on a image usage profile for each of the images, or on an image usage profile associated with a group of digital images.

The image products and image services can include a variety of design elements, color, patterns, pictorial elements, image layouts, image structure, and templates into which digital images are composited. The elements, etc., can be automatically selected based on the design element preferences in the user personalization profile. The preferences in the user personalization file can be automatically determined from the selections that a user makes when designing their personal web pages on a social network website, such as MySpace.

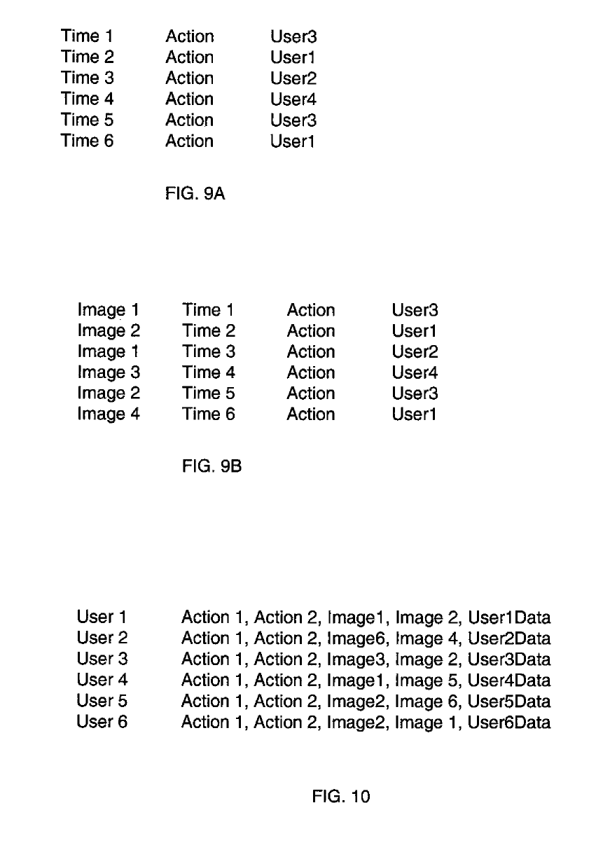

Referring to FIG. 9A, a file having generic entries referring to the use of a particular digital image is illustrated. A digital image use record is a particular type of image usage profile and can include, for example, a time stamp, an action that was taken with regard to a digital image, and the user who performed the action. Referring to FIG. 9B, a file having generic entries referring to the use of a plurality of digital images is illustrated. Referring to FIG. 10, a file containing generic user information includes data about the user and also about actions and digital images used by the user. As with the use record files of FIGS. 9A and 9B, the file of FIG. 10 could be stored as multiple files, one for each user referenced. Alternatively, all of the image use data (FIG. 9B) and user personalization data (FIG. 10) in a profile could be stored in a common file.

In an alternative embodiment of the present invention, image usage profiles and user personalization profiles are analyzed to suggest a possible course of action, such as providing product advertisements, suggested activities, sharing opportunities, or links in an online social network.

The present invention is distinguished from prior-art methods by automatically selecting an image product or image service that incorporates digital images based on user personalization profiles for one or more users and image usage profiles for one or more digital images. Prior-art methods that simply recommend popular products purchased by others do not incorporate a digital image based on an image usage profile or the use of the digital image. Prior-art methods, for example that suggest products that are “more like this”, do not use information in a user personalization profile, or any information about the user, to customize the particular product being suggested. For example, the book or article of clothing that is suggested is not customized to reflect the favorite typeface, or favorite color, of the user. As also noted above, prior-art methods that illustrate products with a customer's digital image do not provide a preferred product recommendation from among a group of image product or service options, based on information in a user personalization profile, or based on any specific information about the particular user.

The determination of favorite digital images, for example as disclosed in U.S. Pat. No. 7,327,505, can rely upon information related to image use. However, this information is used to suggest images to a user once the user has selected a product. In contrast, the present invention can relieve a customer of the burden of determining what products can be made, or would be of interest, and how these products can be customized to suit the tastes of the user, by understanding the relevant customer information about the user's preferences. This can increase customer satisfaction and efficiency.

As a simple example, the image associated with the month of February in a customer's personalized calendar can be proposed as a Valentine's Day card given the knowledge of an appropriate relationship and the former use of the February digital image. Furthermore, the style, typefaces, and design elements of the card can be automatically personalized to best fit the tastes of both the person giving the card, and the person receiving the card, by using the user personalization profile of both individuals.

As another example, when the use records of a sufficient number of images in a collection shows enough interest, the owner of the images can be encouraged to purchase a photo-book, especially if it is known from the profile that the owner has purchased such books in the past. Furthermore, the style, typefaces, and design elements of the photo book can be personalized to best fit the tastes of owner of the digital images.

Similarly, if the image usage profile or digital image use records of a sufficient number of images in a collection show enough interest by a variety of different persons who have an interest in a photo-book, the owner of the images or other persons can be encouraged to purchase photo-books which include these high-interest images. The individual photo-books can be personalized for each of the persons receiving the book, so that they include a common set of images but utilize the style, typefaces, and design elements of each of the persons receiving the book, provided from their user personalization profile.

The present invention provides improvements over conventional marketing methods. User personalization profile information provides an indication of personal preferences, but does not substantially include information concerning the opinions and preferences of others. Hence, user personalization profile information is substantially limited to the experiences of the individual user. In contrast, image use information includes information about image usage by multiple people and thus includes information not available in a user personalization profile. By combining user personalization profile and image use information, better choices can be made for proposed image products and services. As is known in the social sciences, groups often make better decisions than individuals, based on the broader experience of the group members. Hence, the present invention can provide superior image product and service choices and selections for a user.

In this way, providing profiles that can incorporate both information about the personal preferences of a user and information about the usage of each digital image in a collection of digital images can provide automatic selection and customization of an image product or image service.

The invention has been described in detail with particular reference to certain preferred embodiments thereof, but it will be understood that variations and modifications can be effected within the spirit and scope of the invention.

### PARTS LIST

24 system
26 system
28 system
29 printer
30 printer
32 I/O
34 processor
35 I/O
38 sensor
39 memory
40 storage
42 storage
44 storage
46 comm
48 memory
50 interface
52 server
54 system
56 I/O
58 I/O
58a I/O
58b I/O
58c I/O
66 I/O
68 I/O
68a I/O
68b I/O
70 system
72 user
310 client
315 computer network
320 digital image server
325 storage system
330 second server
400 provide image server step
405 receive digital image step
410 form profile step
415 select image product step
420 provide image product step
500 provide image server step
505 receive digital image step
510 form profile step
515 select image product step
517 inform group member step
519 receive request step
520 provide image product step
600 provide image server step
605 receive digital image step
610 form profile step
612 analyze profile step
613 determine preferred group step
615 select image product step
617 inform group member step
619 receive request step
625 sell image product
630 print image product
635 deliver image product
700 provide image server step
705 receive digital image step
710 form profile step
800 provide image server step
805 receive digital image step
810 form profile step
860 employ user profile to select product step
865 employ user profile to select image step
1200 receive user images step
1205 store user images step
1210 request user info step
1215 find user info step
1220 for user profile step
1225 receive user request step
1230 store request info step
1235 store request info step
1240 fulfill user request step
1245 receive user request step
1250 store request info step
1255 store request info step
1260 fulfill user request step
1265 access user info step
1270 access image use info step
1275 make view of product step
1280 show view to user step
1285 receive user acceptance step
1290 make and deliver product step

1. A method for providing imaging products and services, comprising the steps of:
(a) providing a first digital image server having a storage system for storing collections of digital images for a plurality of users in response to a plurality of remote client computers connected to and in communication with the remote server through a computer network;
(b) forming a user personalization profile for each of the plurality of users, each user personalization profile providing personal preferences for one of the plurality of users;
(c) receiving digital images from the plurality of remote client computers and storing the digital images in the storage system on the digital image server;
(d) forming image usage profiles for the stored digital images, the image usage profiles providing data indicating the use of the stored digital images; and
(e) responsive to a particular one of the plurality of users selecting, from a remote client computer, a first image product or service using a first stored digital image, automatically providing a customized offering of a second product or service to the particular user, wherein the customized offering is customized in response to at least one of the image usage profiles and in response to at least one of the user personalization profiles.

2. The method of claim 1 further comprising the steps of receiving a request for the customized offering from the particular user and providing the selected image product or service.

3. The method of claim 1 further comprising the step of automatically providing a customized offering of a second product or service that includes a selected stored digital image to the particular user.

4. The method of claim 3 further comprising the step of customizing the selected image product or service using at least a subset of the information in the image usage profile corresponding to the selected stored digital image.

5. The method of claim 3 further comprising the step of automatically selecting a stored digital image to provide the selected stored digital image to the particular user.

6. The method of claim 1 further comprising the step of forming image usage profiles for the stored digital images, the image usage profiles providing data indicating how often or by whom the stored digital images have been viewed, printed, incorporated into products, or distributed.

7. The method of claim 1 further comprising the step of including information from a social networking website in a user personalization profile.

8. The method of claim 1 further comprising the step of including preferred colors, patterns, objects, music, experiences, images, and videos in a user personalization profile.

9. The method of claim 1, further comprising the steps of analyzing the user personalization profile of the particular user to determine a preferred image product or service and using the determination in the step of providing the customized offering.

10. The method of claim 1, further including the step of selling, printing, or delivering the customized offering.

11. The method of claim 1, further including the step of providing the stored digital images, references to the stored digital images, or access to the stored digital images, to a plurality of users and including information about the provision in the corresponding users' personalization profile.

12. The method of claim 1, further including the step of customizing the offering based on a combined usage of a group of digital images.

13. The method of claim 1, further including the step of including an attribute of a product or service in a user personalization profile.

14. The method of claim 13, further including the step of including design elements, colors, patterns, pictorial elements, image layouts, image structure, or templates in a user personalization profile.

15. The method of claim 1, further including the step of including access hits to a web page that displays the stored digital image in the corresponding image usage profile.

16. The method of claim 1, further including the step of selecting the customized offering based on a user personalization profile for a person other than the particular user.

17. The method of claim 16, further including the step of selecting the other person based on information from the user personalization profile of the particular person.

18. The method of claim 1, further including the step of selecting the customized offering based on attributes associated with a group of which the particular user is a member, the associated attributes being stored in the particular user's personalization profile.

19. The method of claim 1, further including the step of selecting the customized offering based on attributes associated with a group having a member to which the particular user has a relationship, the relationship stored as information in the particular user's personalization profile.

20. A method of analyzing images and user profiles to suggest a possible course of action, comprising the steps of:
receiving a collection of digital images from a user;
allowing the collection of digital images to be viewed, shared;
printed or otherwise used by one or more users;
storing usage information that relates to the usage of each digital image in an image usage profile associated with each digital image;
forming a user personalization profile for each of the one or more users that includes a reference to the digital images that are viewed, shared, printed or otherwise used by the corresponding user;
analyzing the usage information in each of the image usage profiles and the user personalization profile to determine a suggested course of action; and
suggesting the course of action to the owner of the collection of digital images.
